(19) United States
(12) Patent Application Publication
(10) Pub. No.: US 2014/0345836 A1
(43) Pub. Date: Nov. 27, 2014

(54) COIL HEAT EXCHANGER

(71) Applicant: TETRA LAVAL HOLDINGS & FINANCE S.A., Pully (CH)

(72) Inventors: Peter Stövring, Furulund (SE); Mats Lasson, Helsingborg (SE)

(21) Appl. No.: 14/367,887

(22) PCT Filed: Dec. 14, 2012
(86) PCT No.: PCT/EP2012/075561

§ 371 Date: Jun. 20, 2014

(30) Foreign Application Priority Data
Dec. 22, 2011 (SE) 1151264-7
Dec. 22, 2011 (SE) 1151269-6

(51) Int. Cl. F28D 1/02; B23P 15/26; F28F 1/00

(52) U.S. Cl. CPC F28D 1/0213; F28F 1/00; B23P 15/26
USPC 165/163; 29/890.03

(57) ABSTRACT

A coil heat exchanger is provided, comprising a closed vessel having an inlet for receiving heat transfer media and an outlet for discharging heat transfer media, a tubular conduit extending helically within said vessel from a lower part to an upper part of said vessel for transporting liquid products to be heated by said heat transfer media, and an inner housing enclosed by loops of said tubular conduit and sealed against the heat transfer media. The inner housing comprises an open passageway to the environment outside said coil heat exchanger.

### TECHNICAL FIELD

The present invention relates to a coil heat exchanger. More particularly, the present invention relates to an improved coil heat exchanger for transferring heat between a heat transfer media and a liquid product in a liquid product processing system.

### BACKGROUND

Coil heat exchangers are known to provide heat transfer between a heat transfer media, enclosed within a container, and liquid products flowing through a tubular coil extending within the heat transfer media container. Such coil heat exchangers has proven to be particularly efficient for certain types of liquid products having a relatively high viscosity. For example, coil heat exchangers are commonly used within liquid food processing of high viscosity fluids such as purée, dessert pudding, soups, etc. These kinds of fluids flow through the tubular coil, while heat transfer between the heat transfer media and the liquid product is provided.

The container thus stores and transports a very large amount of heat transfer media which flows around the tubular coil in order to provide the desired heat transfer. The flow of the heat transfer media through the container provides an increased pressure within the container why the container is closed at its upper end by a planar head which is tightly screwed onto the container.

For improving the heat exchange efficiency an inner container may be provided such that the loops of the tubular coil enclose the inner housing. Hence, the volume of the container of which heat, transfer media is flowing is significantly reduced, such that flowing heat transfer media is circulated in the area between the inner housing and the container.

In a known coil heat exchanger the inner housing is fluidly connected with the container such that the heat transfer media will fill the inner vessel. Such solution increases the heat transfer efficiency but provides a very long pre-sterilization time due to the need for heating up the stationary amount of heat transfer within the inner housing, which is a major drawback.

Further, the coil heat exchangers used in liquid processing system must allow service and maintenance, while the interior of the coil heat exchanger must be accessible. Therefore, the upper end of the container is sealed by is cylinder head being tightly screwed onto the open upper end of the container.

Since the described coil heat exchangers are used in large-scale processing systems, there are always high demands on the floor supporting it. Having a coil heat exchangers being several meters high, the supporting floor must be carefully constructed in order to provide necessary safety to the processing facilities.

Recent improvements include the provision of a solution in which the inner housing defines a closed space filled with air. The major advantage with such solution is that the total weight of the coil heat exchanger is reduced.

However, any leakage of heat transfer media into the inner housing will reduce the efficiency of the coil heat exchanger as well as increase the total weight. This may occur due to the high pressure within the container, typically being around 10 Bar. Hence, there is a great risk of such solution.

Therefore, there is a need for a coil heat exchanger where the risk of malfunction is reduced. Further, there is a need for a coil heat exchanger which allows for avoiding operation in a failure mode.

### SUMMARY

It is, therefore, an object of the present invention to overcome or alleviate the above described problems.

The basic idea is to provide a coil heat exchanger allowing facilitated failure detection.

A further idea is to provide a coil heat exchanger with reduced weight during operation.

A yet further idea is to provide a coil heat exchanger which has reduced material costs.

According to a first aspect, a coil heat exchanger is provided. The coil heat exchanger comprises a closed vessel having an inlet for receiving heat transfer media and an outlet for discharging heat transfer media, a tubular conduit extending helically within said vessel from a lower part to an upper part of said vessel for transfer liquid products to be heated by said heat transfer media, and an inner housing enclosed by loops of said tubular conduit and sealed against the heat transfer media, wherein said inner housing comprises an open passageway to the environment outside said coil heat exchanger.

The open passageway may in use be arranged at a lower end of said inner housing, whereby small amounts of leakage are easily detected due to the fact that gravity will urge such leaking fluid out from the inner housing to the ground floor.

Said vessel and said inner housing may extend upwards, in use, from a support plate, which is advantageous in that said vessel and said inner housing may be dismounted for allowing service and maintenance of said heat exchanger.

Said vessel may be sealed against said support plate by means of an O-ring. Hence, an efficient sealing is provided in an easy and cost-effective manner.

Said support plate may have a through hole connecting the inner housing with the environment outside said coil heat exchanger. This is advantageous in that any leakage will be transported directly to the floor under the support plate which makes said leakage very easy to detect.

Said vessel and/or said inner housing may have a cylindrical shape, which makes it very robust and easy to manufacture.

The vessel may comprise a tubular body and a closed upper end, wherein said closed upper end may have a curved shape. Hence, the overall weight of the coil heat exchanger is reduced without reducing the pressure resistance and safety of the coil heat exchanger. Said closed upper end of the vessel may further be welded onto said tubular body which eliminates the need for bolts or other fasteners.

The inner housing may comprise a tubular body and a closed upper end, wherein said closed upper end has a curved shape. Also in this case, the overall weight of the coil heat exchanger is reduced without reducing the pressure resistance and safety of the coil heat exchanger.

Said closed upper end of the inner housing may be welded onto said tubular body.

According to a second aspect, a liquid product processing system is provided comprising at least one coil heat exchanger according to the first aspect.

According to a third aspect, a liquid food processing unit is provided comprising a liquid processing system according to the second aspect.

According to a fourth aspect a method for providing a coil heat exchanger is provided. The method comprises the steps of providing a closed vessel having an inlet for receiving heat transfer media and an outlet for discharging heat transfer media, providing a tubular conduit extending helically from a lower part to an upper part of said vessel for transporting liquid products to be heated by said heat transfer media, and providing an inner housing enclosed by loops of said tubular conduit and sealed against the heat transfer media, wherein said inner housing comprises an open passageway to the environment outside said coil heat exchanger.

According to a fifth aspect, a method for exchanging heat between a heat transfer media and liquid product is provided. The method comprises the steps of providing a coil heat exchanger according to the fourth aspect, introducing heat transfer media into said closed vessel, and flowing liquid product through said tubular conduit.

According to a sixth aspect of the present invention, a coil heat exchanger is provided. The coil heat exchanger comprises a closed vessel having an inlet for receiving heat transfer media and an outlet for discharging heating media, a tubular conduit extending helically within said vessel from a lower part to an upper part of said vessel for transporting liquid products to be heated by said heating media, and an inner housing enclosed by loops of said tubular conduit and sealed against the heating media, wherein the vessel comprises a tubular body and a closed upper end, wherein said closed upper end has a curved shape. Hence, the overall weight of the coil heat exchanger is reduced without depriving pressure resistance and safety of the coil heat exchanger.

Said closed upper end of the vessel may be welded onto said tubular body which eliminates the need for bolts or other fasteners.

Said inner housing may comprise an open passageway to the environment outside said coil heat exchanger. This is advantageous in that the risk of malfunction is reduced and in that failure mode operation of the coil heat exchanger may be avoided.

Such passageway may preferably be provided at the lower end of the inner housing, whe leakage may easily be detected due to the fact that gravity will urge leaked fluid out from the inner housing and out on the ground floor.

Said vessel and said inner housing may extend upwards from a support plate which is advantageous in that said vessel and said inner housing may be dismounted for allowing service and maintenance of said heat exchanger.

Said vessel may be sealed against said support plate by means of an O-ring. Hence, an efficient sealing is provided in an easy and cost-effective manner.

Said support plate may have a through hole connecting the inner housing with the environment outside said coil heat exchanger. This is advantageous in that any leakage will be transported directly to the floor under the support plate which makes said leakage very easy to detect.

Said vessel and/or inner housing may have a cylindrical shape, which makes it very robust and easy to manufacture.

The inner housing may comprise a tubular body and a closed upper end, wherein said closed upper end has a curved shape. Hence, the overall weight of the coil heat exchanger is reduced without reducing the pressure resistance and safety of the coil heat exchanger.

Said closed upper end of the inner housing may be welded onto said tubular body.

According to a seventh aspect, a liquid product processing system is provided comprising at least one coil heat exchanger according to sixth aspect.

According to an eighths aspect, a liquid food processing unit is provided comprising a liquid processing system according to the seventh aspect.

According to a ninth aspect, a method for providing a coil heat exchanger is provided. The method comprises the steps of providing a closed vessel having an inlet for receiving heat transfer media and an outlet for discharging heating media, providing a tubular conduit extending helically from a lower part to an upper part of said vessel for transporting liquid products to be heated by said heating media, and providing an inner housing enclosed by loops of said tubular conduit and sealed against the heating media, wherein the vessel comprises a tubular body and a closed upper end, and wherein said closed upper end has a curved shape.

According to a tenth aspect a method for exchanging heat between a heat transfer media and liquid product is provided. The method comprises the steps of providing coil heat exchanger according to the ninth aspect, introducing heat transfer media into said closed vessel, and flowing liquid product through said tubular conduit.

### BRIEF DESCRIPTION OF DRAWINGS

The above, as well as additional objects, features, and advantages of the present invention, will be better understood through the following illustrative and non-limiting detailed description of preferred embodiments of the present invention, with reference to the appended drawing, of which:

FIG. 1 is a cross-sectional view of a coil heat exchanger according to an embodiment.

### DETAILED DESCRIPTION

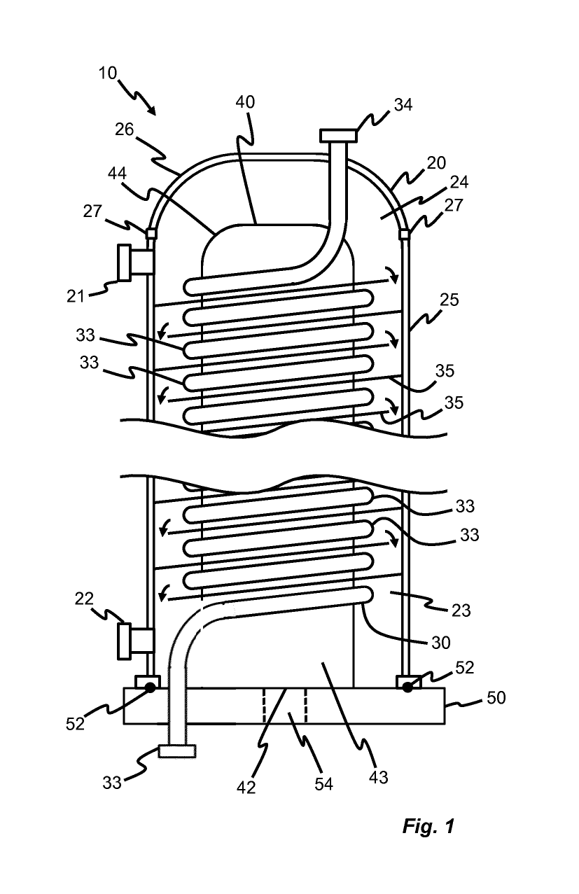

Starting with FIG. 1 a coil heat exchanger 10 is shown. The coil heat exchanger 10 is formed by a closed vessel 20 extending from a support plate 50. The vessel 20 has a cylindrical shape and includes a tubular body 25 attached to said support plate 50, and a closed upper end 26. The vessel 20 includes an inlet 21 for receiving heat transfer media, such as water, and an outlet 22 for discharging the heat transfer media. The net 21 and the outlet 22 may be connected to adjacent heat transfer media equipment (not shown) such as a balancing tank, a heater, etc.

The vessel 20 is preferably attached to the support plate 50 by means of bolts (not shown), and an O-ring 52 is preferably provided for ensuring sufficient sealing of the vessel 20 to the support plate 50.

The closed upper end 26 of the vessel 20 has a curved shape, which is advantageous in that it may withstand a higher internal pressure compared to a planar closed upper end. Further, the closed upper end 26 may be welded to the tubular body 25 such that no additional sealing between the closed upper end 26 and the tubular body 25 is necessary. The welding is preferably provided along a welding line 27 extending along the periphery of the vessel 20.

The curvature of the closed upper end 26 may preferably be symmetrical, and may e.g. follow the shape of a semi-sphere. However other curved shapes are also possible, as long as they provide an increased resistance to internal pressure than a planar upper end.

The closed upper end 26 may further be provided with lifting means, such as hooks or similar, for allowing the vessel 20 to be dismounted from the support plate 50 once the attachment means, e.g. bolts, connecting the vessel 20 to the support plate 50 have been released.

By providing a curved upper end 26 the material thickness may be reduced significantly than if a planar top would be used. Hence, the overall weight of the coil heat exchanger is reduced.

A tubular conduit 30 is arranged within said vessel 20. The tubular conduit has a helical shape corresponding to a coil, and extends from a lower part 23 of the vessel 20 to an upper part 24 of the vessel 20. Due to the coil shape the tubular conduit 30 forms a number of loops 32 for transporting liquid product introduced at a liquid product inlet 33 and discharged at a liquid product outlet 34. The inlet 33 and the outlet 34 of the tubular conduit may be connected to further liquid product processing equipment (not shown), such as heaters, coolers, homogenizers, etc.

Each loop 33 of the tubular conduit 30 may extend along a baffle 35. Each baffle is provided as a plate, sealed against a part of the inner periphery of the tubular body 25 of the vessel 20, and leaving a space towards an opposite side of the inner periphery of the vessel 20. The baffles 35 are preferably arranged in a zigzag pattern for forcing the heat transfer media to flow around the entire tubular conduit 30. Hence, the baffles 35 are provided for increasing the heat, transfer efficiency of the coil heat exchanger 10.

The tubular conduit 30 may form a plurality of loops 33, wherein the exact number of loops 33 is dependent on the particular heat transfer. For example, the number of loops may be between 5 and 50, although other alternatives are possible in order to provide the desired heat transfer.

An inner housing 40 is further provided in the space enclosed by the loops 33 of the tubular conduit 30. The inner housing 40 is sealed against the heat transfer media for preventing the heat transfer media to enter the inner housing 40. Further, the interior of the inner housing 40 is subjected to atmospheric pressure such that the inner housing 40 forms a pressure chamber capable of withstanding the outside pressure of the heat transfer media.

The baffles 35 are further sealed against the outer periphery of the inner housing 40.

Air is allowed to enter the interior of the inner housing 40 via an open passageway 42 extending through the support plate 50 via a through hole 54. Hence, the inner housing 40 is preferably provided as a hollow body, which was are attached to the support plate 50. Hence, the inner housing 40 may rest on the support pate 50 such that the entire periphery of the open end of the inner housing 40 is in close contact with the support plate 50. The outer diameter of the inner housing 40 may be constant from the open end to the closed upper end; however the diameter naturally decreases in case a curved upper end is provided. Nevertheless, the inner housing 40 will thus be supported in a very robust manner by the support plate 50.

Any leakage of heat transfer media into the inner housing 40 will thus result in a detectable amount of heat transfer media on the floor supporting the coil heat exchanger 10, why the desired operation of the coil heat exchanger 10 may be easily monitored.

The inner housing 40 may preferably be provided as a tubular body 43 having an upper closed end 44. The closed upper end 44 of the inner housing 40 may have a curved shape, which is advantageous in that it may withstand a higher external pressure compared to a planar closed upper end. Further, the closed upper end 44 may be welded to the tubular body 43 such that no additional sealing between the closed upper end 44 and the tubular body 43 is necessary.

An example of typical coil heat exchanger for processing liquid products will now be described, which coil heat exchanger has a tubular conduit being approximately 100 m long and having a conduit diameter of approximately 48 mm. The tubular conduit is arranged helically such that it may be enclosed in an outer vessel having a height of approximately 4 m. Replacing the prior art planar top with a curved upper end being welded onto the tubular portion of the vessel the empty weight of the coil heat exchanger is reduced from approximately 1600 kg to 1300 kg.

With the further provision of an air-filled inner housing instead of a housing filled with heat transfer made the operational weight of the coil heat exchanger, i.e. when the vessel and the tubular conduit are filled, is reduced from approximately 3170 kg down to approximately 2050 kg.

When a coil heat exchanger according to the embodiments previously described is started, heat transfer media is introduced into the vessel 20. The heat transfer media flowing between the inlet 21 and the outlet 22 will cause a pressure increase within the vessel 20, typically around 10 Bar. When the vessel 20 is completely filled with heat transfer media liquid products are introduced into the tubular conduit 30. The pressure within the tubular conduit is normally very high, e.g. between 100 and 320 Bar. The coil-shaped tubular conduit will induce a so called Dean effect, which means that the product flow within the tubular conduit will be subject to a centrifugal force creating a flow perpendicular to the longitudinal direction of the tubular conduit. Hence, mixing of the liquid product is increased leading to increased heat transfer efficiency.

The baffles 35 force the heat transfer media to flow according to a predetermined flowing path, whereby the moving heat transfer media is in contact with the entire tubular conduit. The flow of the heat transfer media is indicated by the arrows in FIG. 1.

If heat transfer media is suddenly beginning to leak into the inner housing 40 the open passageway 42 makes it very easy for an operator to request maintenance and service of the coil heat exchanger 10. If heat transfer media is allowed to fill the inner housing 40 the total weight of the coil heat exchanger 10 rapidly increases, and at the same time the pre-sterilization time of the coil heat exchanger 10 increases. Hence, leakage detection is an important functionality which is provided by means of the passageway 42 connecting the inner vessel with the surrounding environment.

The invention has mainly been described with reference to a few embodiments. However, as is readily understood by a person skilled in the art, other embodiments than the ones disclosed above are equally possible within the scope of the invention, as defined by the appended claims.

1. A coil heat exchanger, comprising
a closed vessel having an inlet for receiving heat transfer media and an outlet for discharging heat transfer media,
a tubular conduit extending helically within said vessel from a lower part to an upper part of said vessel for transporting liquid products to be heated or cooled by said heat transfer media, and
an inner housing enclosed by loops of said tubular conduit and sealed against the heat transfer media, wherein said inner housing comprises an open passageway to the environment outside said coil heat exchanger.

2. The coil heat exchanger according to claim 1, wherein said open passageway is arranged at a lower end of said inner housing.

3. The coil heat exchanger according to claim 1, wherein said vessel and said inner housing extends upwards from a support plate.

4. The coil heat exchanger according to claim 3, wherein said vessel is sealed against said support plate by an O-ring.

5. The coil heat exchanger according to claim 3, wherein said support plate has a hole connecting the inner housing with the environment outside said coil heat exchange.

6. The coil exchanger according to claim 1, wherein said vessel has a cylindrical shape.

7. The coil heat exchanger according to claim 1, wherein said inner housing has a cylindrical shape.

8. The coil heat exchanger according to claim 1, wherein the vessel comprises a tubular body and a closed upper end, wherein said closed upper end has a curved shape.

9. The coil heat exchanger according to claim 8, wherein said closed upper end of the vessel is welded onto said tubular body.

10. The coil heat exchanger according to claim 1, wherein the inner housing comprises a tubular body and a closed upper end, wherein said closed upper end has a curved shape.

11. The coil heat exchanger according to claim 10, wherein said closed upper end of the inner housing is welded onto said tubular body.

12. A liquid product processing system, comprising at least one coil heat exchanger according to claim 1.

13. A liquid food processing unit, comprising a liquid processing system according to claim 12.

14. A method for providing a coil heat exchanger, comprising:
providing a closed vessel having an inlet for receiving heat transfer media and an outlet for discharging heat transfer media,
providing a tubular conduit extending helically from a lower part to an upper part of said vessel for transporting liquid products to be heated by said heat transfer media, and
providing an inner housing enclosed by loops of said tubular conduit and sealed against the heat transfer media, wherein said inner housing comprises an open passageway to the environment outside said coil heat exchanger.

15. A method for exchanging heat between a heat transfer media and liquid product, comprising:
providing a coil heat exchanger according to claim 14, introducing heat transfer media into said closed vessel; and flowing liquid product through said tubular conduit.
